(19) United States
(12) Patent Application Publication
(10) Pub. No.: US 2002/0041991 A1
(43) Pub. Date: Apr. 11, 2002

(54) Sol-gel derived fuel cell electrode structures and fuel cell electrode stack assemblies

(76) Inventors: Chung M. Chan, Bellevue, WA (US); Jonathan C. Mallari, Seattle, WA (US); Aaron M. Cooke, Seattle, WA (US)

Correspondence Address: Thomas E. Loop, of Loop Intellectual Property Law PLLC, Post Office Box 21346, Seattle, WA, 98111-3346, US

(21) Appl. No.: 09/839,950

(22) Filed: Apr. 19, 2001

Related U.S. Application Data
(63) Continuation-in-part of application No. 09/715,830, filed on Nov. 17, 2000.
(60) Provisional application No. 60/200,866, filed on May 2, 2000.
(60) Provisional application No. 60/189,205, filed on Mar. 14, 2000.
(60) Provisional application No. 60/166,372, filed on Nov. 17, 1999.

(51) Int. Cl. H01M 4/86; H01M 4/90; H01M 4/92

(52) U.S. Cl. 429/44

(57) ABSTRACT

The present invention is directed to sol-gel derived electrode structures and sol-gel derived electrode assemblies associated with fuel cell systems, as well as to methods relating thereto. In one embodiment, the present invention is directed to electrode structure adapted for use with a fuel cell system such as, for example, a direct methanol fuel cell system. In this embodiment, the invention may be characterized in that the electrode structure comprises a support substrate or structure having a one or more discrete porous regions, wherein each of the one or more discrete porous regions comprise a sol-gel. The sol-gel of the present invention comprises platinum ruthenium dioxide, platinum-ruthenium-silicon oxide, platinum-ruthenium-titanium oxide, platinum-ruthenium-zirconium oxide, platinum-ruthenium-aluminum oxide, or a combination thereof, preferably, however, the sol-gel comprises platinum ruthenium dioxide.

### CROSS-REFERENCE TO RELATED APPLICATIONS

This application is a continuation-in-part of U.S. patent application No. 09/715,830 filed Nov. 17, 2000; which application claims priority to U.S. Provisional Patent Application No. 60/200,866 filed May 2, 2000; U.S. Provisional Patent Application No. 60/189,205 filed Mar. 14, 2000; and U.S. Provisional Patent Application No. 60/166,372 filed Nov. 17, 1999; all of which are incorporated herein by reference in their entireties.

### TECHNICAL FIELD

The present invention relates generally to fuel cell systems and, more specifically, to sol-gel derived electrode structures and sol-gel derived electrode assemblies associated with fuel cell systems.

### BACKGROUND OF THE INVENTION

A fuel cell is an energy conversion device that consists essentially of two opposing electrodes, an anode and a cathode, ionically connected together via an interposing electrolyte. Unlike a battery, fuel cell reactants are supplied externally rather than internally. Fuel cells operate by converting fuels, such as hydrogen or methanol, to electrical power through an electrochemical process rather than combustion. It does so by harnessing the electrons released from controlled oxidation-reduction reactions occurring on the surface of a catalyst. A fuel cell system can produce electricity continuously so long as fuel is supplied from an outside source.

In electrochemical fuel cells employing methanol as the fuel supplied to the anode (also commonly referred to as a “Direct Methanol Fuel Cell” (DMFC) system), the electrochemical reactions are essentially as follows: first, a methanol molecule's carbon-hydrogen, and oxygen-hydrogen bonds are broken to generate electrons and protons; simultaneously, a water molecule's oxygen-hydrogen bond is also broken to generate an additional electron and proton. The carbon from the methanol and the oxygen from the water combine to form carbon dioxide. Oxygen from air supplied to the cathode is reduced to anions with the addition of electrons. From a molecular perspective, the electrochemical reactions occurring within a direct methanol fuel cell (DMFC) are as follows:

$$\begin{matrix}\text{Anode:} & {CH}_{3} OH + {H}_{2} O \to 6 {H}^{+} + 6 {e}^{-} + {CO}_{2} & {E}_{0} = 0.04 V & \text{vs. NHE} & ( 1 ) \\ \text{Cathode:} & \frac{3}{2} {O}_{2} + 6 {H}^{+} + 6 {e}^{-} \to 3 {H}_{2} O & {E}_{0} = 1.23 V & \text{vs. NHE} & ( 2 ) \\ \text{Net:} & {CH}_{3} OH + \frac{3}{2} {O}_{2} \to {H}_{2} O + {CO}_{2} & {E}_{0} = 1.24 V & \text{vs. NHE} & ( 3 )\end{matrix}$$

The various electrochemical reactions associated with other state-of-the-art fuel cell systems (e.g., hydrogen or carbonaceous fuel) are likewise well known to those of ordinary skill in the art.

With respect to state-of-the-art fuel cell systems generally, several different configurations and structures have been contemplated—most of which are still undergoing further research and development. In this regard, existing fuel cell systems are typically classified based on one or more criteria, such as, for example, (1) the type of fuel and/or oxidant used by the system, (2) the type of electrolyte used in the electrode stack assembly, (3) the steady-state operating temperature of the electrode stack assembly, (4) whether the fuel is processed outside (external reforming) or inside (internal reforming) the electrode stack assembly, and (4) whether the reactants are fed to the cells by internal manifolds (direct feed) or external manifolds (indirect feed). In general, however, it is perhaps most customary to classify existing fuel cell systems by the type of electrolyte (i.e., ion conducting media) employed within the electrode stack assembly. Accordingly, most state-of-the-art fuel cell systems have been classified into one of the following known groups:

1. Alkaline fuel cells (e.g., electrolyte is KOH);

2. Acid fuel cells (e.g., electrolyte is phosphoric acid);

3. Molten carbonate fuel cells (e.g., electrolyte is 63% Li₂CO₃/37% K₂CO₃);

4. Solid oxide fuel cells (e.g., electrolyte is yttria-stabilized zirconia);

5. Proton or ion exchange membrane fuel cells (e.g., electrolyte is NAFION).

Although these state-of-the-art fuel cell systems are known to have many diverse structural and operational characteristics, such conventional systems nevertheless share common characteristics with respect to their electrode design. For example, conventional fuel cell electrode structures are generally constructed to serve two principal functions: (1) the first is to electrocatalyze the fuel or oxidizer, and (2) the second is to electrically conduct released electrons out of the fuel cell and to the electrical load. Because these two principal functions are generally not obtainable by a single state-of-the-art electrode material, most conventional electrode designs comprise a layered structure that includes, for example, a support substrate (e.g., a graphite or plastic plate having a flow field channel patterned thereon), a catalytic active layer (e.g., a carbon-fiber sheet or layer having affixed or embedded catalyst particles), and a current collector layer (e.g., a gold mesh) for the transmission of the generated electrical current. Such conventional electrode designs may be advantageous for vehicular and other larger scale power applications, but are problematic for smaller scale stationary applications such as, for example, miniature fuel cell systems for portable electronic applications. In short, conventional electrode platforms (with their several layers of disparate materials) are difficult to fabricate on a micro-scale basis.

Although significant progress has been made with respect to these and other fuel cell system problems, there is still a need in the art for improved fuel cell electrode structures and fuel cell electrode stack assemblies, as well as to methods relating thereto. The present invention fulfills these needs and provides for further related advantages.

### SUMMARY OF THE INVENTION

In brief, the present invention relates generally to fuel cell systems and, more specifically, to sol-gel derived electrode structures and sol-gel derived electrode assemblies associated with fuel cell systems, as well as to methods relating thereto. In one embodiment, the present invention is directed to electrode structure adapted for use with a fuel cell system such as, for example, a direct methanol fuel cell system. In this embodiment, the invention may be characterized in that the electrode structure comprises a support substrate or structure having a one or more discrete porous regions, wherein each of the one or more discrete porous regions comprise a sol-gel. The sol-gel of the present invention comprise platinum ruthenium dioxide, platinum-ruthenium-silicon oxide, platinum-ruthenium-titanium oxide, platinum-ruthenium-zirconium oxide, platinum-ruthenium-aluminum oxide, or a combination thereof; preferably, however, the sol-gel comprises platinum ruthenium dioxide.

These and other aspects of the present invention will become more evident upon reference to following detailed description and attached drawings. It is to be understood that various changes, alterations, and substitutions may be made to the teachings contained herein without departing from the spirit and scope of the present invention. It is to be further understood that the drawings are illustrative (hence, not necessarily to scale) and symbolic representations of exemplary embodiments of the present invention.

### BRIEF DESCRIPTION OF THE DRAWINGS

FIGS. 1-37 illustrate sequential side cross-sectional views of a silicon substrate that has been subjected to various process steps to form a sol-gel derived anode structure in accordance with an embodiment of the present invention.

FIGS. 38-73 illustrate sequential side cross-sectional views of a silicon substrate that has been subjected to various process steps to form a sol-gel derived cathode structure in accordance with an embodiment of the present invention.

### DETAILED DESCRIPTION OF THE INVENTION

The present invention is directed to sol-gel derived electrode structures and sol-gel derived electrode assemblies associated with fuel cell systems, as well as to methods relating thereto. In this regard, it has been discovered that a sol-gel, optionally integrated with a support structure such as, for example, a silicon substrate (e.g., a silicon wafer), is a highly advantageous platform for fabricating electrode structures associated with fuel cell systems such as, for example, direct methanol fuel cell systems for portable electronic applications. Some of the advantages that a sol-gel platform provides include: (1) the ability to function as a catalyst, (2) the ability to uniformly carry a catalyst on a surface or within a bulk fluid flow-through matrix, (3) the ability to function as a current collector for the transmission of an electrical current, and (4) the ability to be selectively sculpted, metallized and processed into complicated structures via semiconductor micro-fabrication techniques.

Accordingly, an aspect of the present invention relates to the use of a sol-gel derived support structure for carrying a catalyst, wherein the sol-gel derived support structure together with the catalyst serve as an electrode structure of a fuel cell system. Thus, and in one aspect, the present invention is directed to an electrode made from a sol-gel derived support structure (optionally integrated together with a silicon substrate). As is appreciated by those skilled in the art, sol-gel processes are a way to make dispersed ceramic materials through the growth of metal oxo polymers in a solvent. (see, e.g., Brinker et al., “Sol-Gel Science, the Physics and Chemistry of Sol-Gel Processing,” Academic (1990).) The chemistry associated with sol-gel processes is based on inorganic polymerization reactions. In this regard, metal oxo polymers may be obtained through hydrolysis and condensation of molecular precursors such as metal alkoxides M(OR)z (wherein M Si, Ti, Al, Zr, V, W, Ir, Mn, Mo, Re, Rh, Nb, Ni, Sr, Ba, Ta, Mg, Co; OR is an alkoxy group and Z is the valence or oxidation state of the metal) (Sanchez et al., “Inorganic and Organometallic Polymers with Special Properties,” Nato ASI Series (Laine R. M., Ed.), 206:267 (1992)).

The reaction proceeds first through the hydroxylation of metal alkoxides, which occurs upon the hydrolysis of alkoxy groups as follows:

M−OR+H₂O→M−OH+ROH (4)

The mechanism occurs in three steps: (a) nucleophilic attack of the metal M by the oxygen atom of a water molecule; (b) transfer of a proton from the water to an OR group of the metal; and (c) release of the resulting ROH molecule (Livage et al., “Sol-Gel Chemistry of Transition-Metal Oxides,” Progress in Solid State Chemistry, 18(4):259-341 (1988)).

As soon as reactive hydroxy groups are generated, the formation of branched oligomers and polymers with a metal oxo based skeleton and reactive residual hydroxo and alkoxy groups occurs through a polycondensation process. Depending on experimental conditions, two competitive mechanisms have been described, namely, oxolation and olation.

Oxolation involves the formation of oxygen bridges as follows:

M−OH+M−OX→M−O−M+XOH (5)

(X=H or alkyl group)

As with hydrolysis, oxolation is a three step nucleophilic substitution reaction which occurs through the elimination of H₂O or ROH. Generally, under a stoichiometric hydrolysis ratio (h=H₂O/M<2) the alcohol producing condensation is favored, whereas the water forming condensation is favored for larger hydrolysis ratio (h>>2) (Brinker et al., “Sol-Gel Science, the Physics and Chemistry of Sol-Gel Processing,” Academic (1990)).

Olation, on the other hand, involves the formation of hydroxo bridges as follows:

M−OH+HO−M→M−(OH)₂−M (6)

Olation is a nucleophilic addition reaction that can take place when the coordination of the metallic center is not fully satisfied (N−Z>0). The hydroxo nucleophilic group enters the unsaturated coordination sphere of the metal. This reaction does not need the proton transfer described above (step b) and the removal of a leaving group (step c). Consequently, the kinetics of olation are usually faster than those of oxolation because steps b and c are not necessary (Sanchez et al., “Inorganic and Organometallic Polymers with Special Properties,” Nato ASI Series (Laine R. M., Ed.), 206:267 (1992)).

In accordance with an aspect of the present invention, these three reactions (hydrolysis, oxolation and olation) may all be involved in the transformation of a metal alkoxide precursor into a metal oxo macromolecular network, where such a metal oxo macromolecular network is referred to herein as a sol-gel derived support structure. The exact structure and morphology of such a sol-gel derived support structure generally depends on the relative contribution of each of these reactions.

In exemplary embodiments of the present invention, a sol-gel derived support structure may be cast into etched or micromachined trenches, channels, and/or pits of a silicon substrate (e.g., a silicon wafer with selectively placed trenches), wherein the sol-gel derived support structure combined with the silicon substrate (together with the catalyst) serves as an electrode of a fuel cell system. In this context, exemplary sol recipes (chemicals are commercially available from Aldrich Chemical Company, Inc., Milwaukee, Wis.) useful in the practice of the present invention are as follows are as follows:

Pt—RuO₂

A platinum-ruthenium oxide precursor solution may be prepared by mixing dihydrogen hexahydroxyplatinate (IV) (H₂Pt(OH)₆), ruthenium(III) 2-4pentanedionate Ru(C₅H₇O₂)₃ with nitric acid (HNO₃), ethyl alcohol (C₂H₅OH), and de-ionized water. The solution may be refluxed under vigorous stirring at ˜70° C. for ˜2 hrs to yield a nominal molar ratio of 1: 0.5: 5: 5: 0.5 of: Ru(C₅H₇O₂)₃: H₂Pt(OH)₆: H₂O: C₂H₅OH: HNO₃.

Pt—RuO₂—SiO₂

A platinum-ruthenium-silicon oxide precursor solution may be prepared by first mixing hexachloroplatinic acid (H₂PtCl₆ xH₂O), ruthenium chloride hydrate (RuCI₃ XH₂O) and tetraethoxysilane (Si(OC₂H₅)₄) in ethyl alcohol (C₂H₅OH). A solution of ammonium hydroxide (NH₄OH) and de-ionized water may then added to the refluxing mixture under vigorous stirring at ˜70° C. for ˜2 hrs to yield a nominal molar ratio of 1: 0.2 : 0.5 : 5 : 5 : 0.8 of RuCl₃ XH₂O: Si(OC₂H₅)₄: H₂PtCl₆xH₂O: H₂O: C₂H₅OH: NH₄OH.

Pt—RuO₂—TiO₂

A platinum-ruthenium-silicon oxide precursor solution may be prepared by first mixing dihydrogen hexahydroxyplatinate (IV) (H₂Pt(OH)₆) and ruthenium (III) 2-4pentanedionate Ru(C₅H₇O₂)₃ in ethyl alcohol, refluxed and stirred at ˜70° C. for 3hrs. Separately, titanium (IV) isopropoxide (Ti[OCH(CH₃)₂]₄) may also mixed with thyl alcohol (C₂H₅OH), refluxed and stirred at ˜70° C. for 3hrs. Next, the two solutions may be mixed together, refluxed under stirring at ˜70° C. for 3hrs. Lastly, a solution of nitric acid (HNO₃) and de-ionized water may be added to the mixture, refluxed and stirred at ˜70° C. for ˜2 hrs to yield a nominal molar ratio of 1: 0.2 : 0.5 5: 5: 0.5 of Ru(C₅H₇O₂)₃: Ti[OCH(CH₃)₂]₄: H₂Pt(OH)₆: H₂O: C₂H₅OH: HNO3.

In accordance with certain preferred embodiments of the present invention, any of the aboves sols may be cast into etched or micromachined trenches, channels, and/or pits of a silicon wafer, and more preferably, into an etched region of porous silicon. It has been found that the pores of a porous silicon substrate facilitates a mechanical interlocking mechanism for anchoring the sol-gel (thereby reducing the risk of delamination). (Note also that a 5-50 nm layer of ruthenium oxide deposited by chemical vapor deposition may also improve the adhesion of the sol-gel to the underlying silicon substrate. Thus, an aspect of the present invention relates to the use of porous silicon as a support substrate or structure for a sol-gel. In this regard, the novel porous silicon substrates (and/or support structures) of the present invention may be formed by silicon micro-machining and/or wet chemical techniques (employed by the semiconductor industry) such as, for example, anodic polarization of silicon in hydrofluoric acid. As is appreciated by those skilled in the art, the anodic polarization of silicon in hydrofluoric acid (HF) is a chemical dissolution technique and is generally referred to as HF anodic etching; this technique has been used in the semiconductor industry for wafer thinning, polishing, and the manufacture of thick porous silicon films. (See, e.g., Eijkel, et al., “A New Technology for Micromachining of Silicon: Dopant Selective HF Anodic Etching for the Realization of Low-Doped Monocrystalline Silicon Structures,” IEEE Electron Device Ltrs., 11(12):588-589 (1990)). In the context of the present invention, it is to be understood that the porous silicon may be nanoporous silicon (i.e., average pore size<2 nm), mesoporous silicon (i.e., average pore size of 2 nm to 50 nm), or macroporous silicon (i.e., average pore size>50 nm). In addition, the porous regions of the silicon may be of any morphology such a, for example, a branched and interconnecting network of mesoporous and macroporous acicular pores as well as a “Kielovite” porous structure.

More specifically, porous silicon substrates useful in the context of the present invention may be formed by a photoelectrochemical HF anodic etching technique, wherein selected oxidation-dissolution of silicon occurs under a controlled current density. (See, e.g, Levy-Clement et al., “Porous n-silicon Produced by Photoelectrochemical Etching,” Applied Surface Science, 65/66:408-414 (1993); M. J. Eddowes, “Photoelectrochemical Etching of Three-Dimensional Structures in Silicon,” J. of Electrochem. Soc., 137(11):3514-3516 (1990).) An advantage of this relatively more sophisticated technique over others is that it is largely independent of the different principal crystallographic planes associated with single-crystal silicon wafers (whereas most anisotropic wet chemical etching methods have very significant differences in rates of etching along the different principal crystallographic planes). The photoelectrochemical HF anodic etching of n-type silicon, for example, depends upon, among other things, the existence of holes (h⁺) at or near the silicon surface/solution interface. As is appreciated by those skilled in the art, such holes may be generated by illumination of the silicon surface (n-type); and the holes' transport or flux to the silicon/solution interface may be controlled by an applied potential bias (together with its associated electric field). Once at or near the silicon/solution interface, the photogenerated holes may take part in oxidation-reduction reactions with surface atoms. In a suitable electrolyte HF solution, oxidation-reduction will be followed by dissolution of the oxidation product such that etching will proceed. (Note that for p-type silicon, holes are readily available so there is generally no need for photo-illumination.)

Several chemical oxidation-dissolution models have been reported to explain the reaction mechanism that occurs during the electrochemical HF anodic etching of silicon. Perhaps, the most popular model is the one proposed by Lehmann and Gosele. (Lehmann et al., “Porous Silicon Formation: A Quantum Wire Effect,” Applied Physics Letter, 58(8)856-858 (1991)). The mechanism proposed by Lehmann and Gosele is schematically depicted below in chemical equation (7).

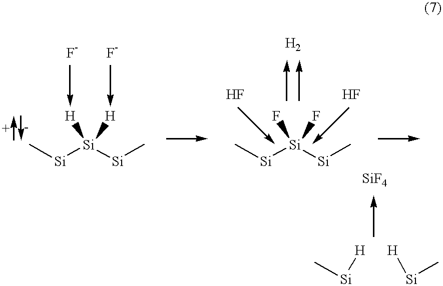

According to the Lehmann and Gosele model as represented by chemical equation (7), silicon, when immersed in a HF solution, will form a Si—H bond on the surface. The holes and their transport to or near the silicon surface/solution interface (caused by supplying a voltage together IR illumination for n-type silicon) reduces the strength of the Si—H bonds thereby allowing formation of Si—F₂, which, in turn, results in a weakening of the Si—Si bonds. Hydrofluoric acid form the solution then causes the weakened Si—Si bond to break, thereby causing the formation of SiF₄, which, in turn, goes into the surrounding solution.

In order to form porous silicon substrates by a photoelectrochemical HF anodic etching technique as described above, it is necessary to either obtain or construct an anodic etching cell. In this regard, a suitable anodic etching cell may be obtained commercially from Advanced Micromachining Tools GmbH (Frankenthal, Germany); alternatively, an appropriate anodic etching cell may be constructed.

Another aspect of the present invention relates to a noncontiguous bi-metallic dispersion of platinum and ruthenium particles chemisorbed on and/or within a porous sol-gel derived substrate (deposited by selective use of platinum and ruthenium precursors). For example, a ruthenium dioxide sol-gel substrate may be immersed, under basic conditions (pH 8.5), into an aqueous ammonia solution of tetraamineplatinum(II) hydroxide hydrate, [Pt(NH₃)₄](OH)₂-xH₂O, (commercially available from Strem Chemicals, Inc., Newburyport, Maine) and stirred for a selected period of time, resulting in the formation of a surface bound platinum complex, equation (8).

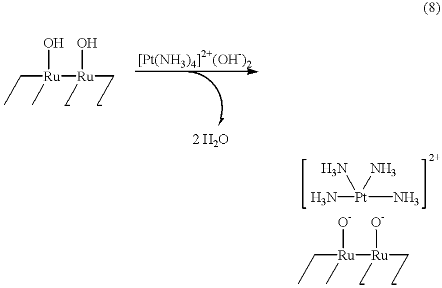

After washing with cold water, the ruthenium dioxide substrate may then be calcined in air to remove the remainder of the ligands from the platinum. This step may be done under a slow temperature ramp, 25° C. −400° C., over a selected period of time. The catalyst may then be reduced under flowing H₂ at 400° C. (1% in nitrogen) to reduce the platinum followed by heating at 200° C. in air to ensure the surface of the ruthenium dioxide is fully oxidized, equation (9).

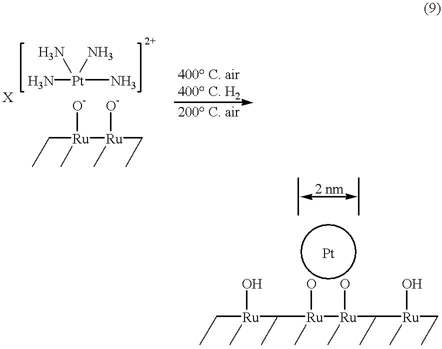

For purposes of illustration and not limitation, the following examples more specifically disclose various aspects of the present invention.

### EXAMPLES

### Example 1 Sol-gel Derived Electrode Structures

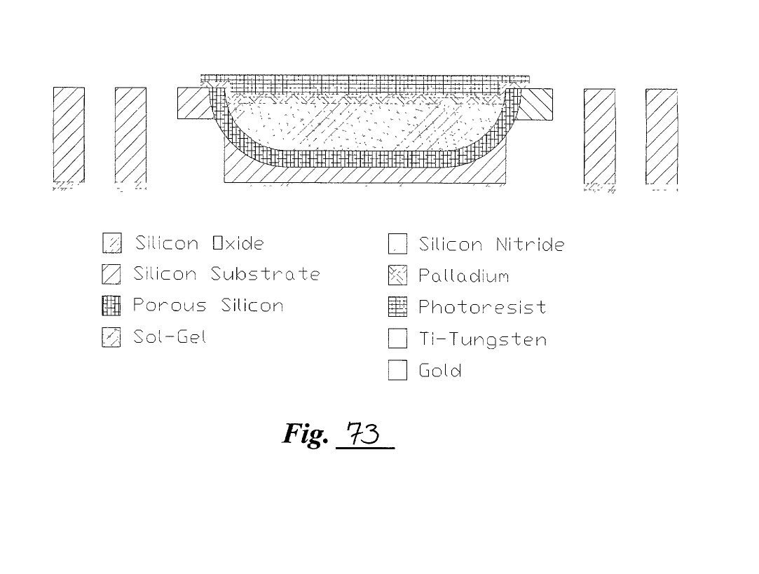

This example discloses the processing steps associated with making a sol-gel-based electrode assembly adapted for use with a fuel cell system. In this example, the processing steps consist essentially of (1) the anode fabrication steps, and (2) the cathode fabrication steps. Without limitation, the principal processing steps are set forth below and with reference to FIGS. 1 to 73.

ANODE FABRICATION-Start with a silicon substrate having the following characteristics: (100) crystal orientation, 1 to 10 Ω-cm, n-type, 100 mm diameter, 300+/−2 μm double side polished prime (DSPP), TTV<1 μm, and process in accordance with the following steps:

1.1 Grow 5000 Å, both sides of wet thermal oxide (SiO₂) on both sides of wafer. Deposit 600 Å, stoichiometric LPCVD silicon (Si₃N₄) on both sides of wafer (refer to FIG. 1).

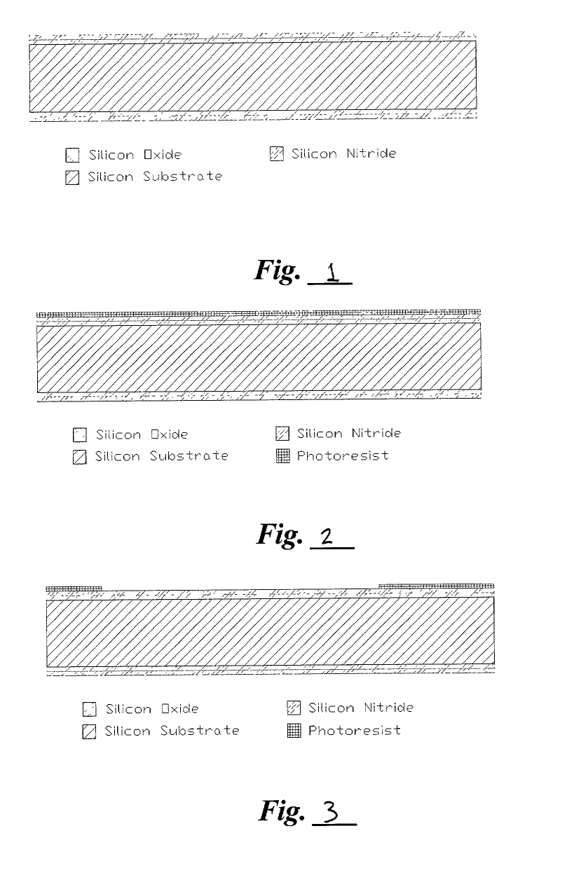

1.2 Spin on AZ 1512 photoresist (refer to FIG. 2).

1.3 Expose with Photomask A2-1F-KOH1 for front side (refer to FIG. 3).

1.4 RIE dielectrics on front side (refer to FIG. 4).

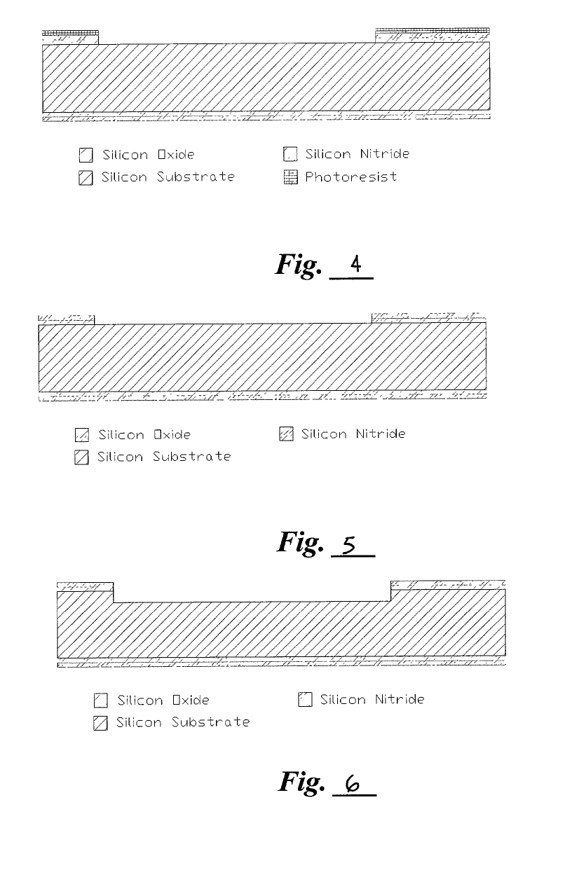

1.5 Strip photoresist and clean wafer (refer to FIG. 5).

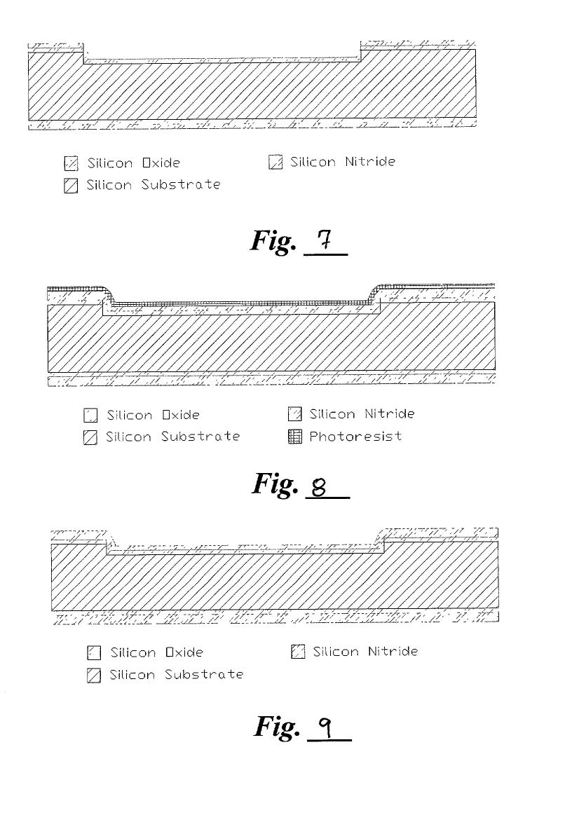

1.6 KOH etch 100 μm in stirred 28% KOH, at 75° C. (refer to FIG. 6).

1.7 Grow 3000 Å wet thermal oxide, (SiO₂) on exposed Si regions (refer to FIG. 7).

1.8 Deposit 600 Å of silicon nitride, Si₃N₄ (refer to FIG. 8).

1.9 Spin on AZ4620 photoresist on front side (refer to FIG. 9).

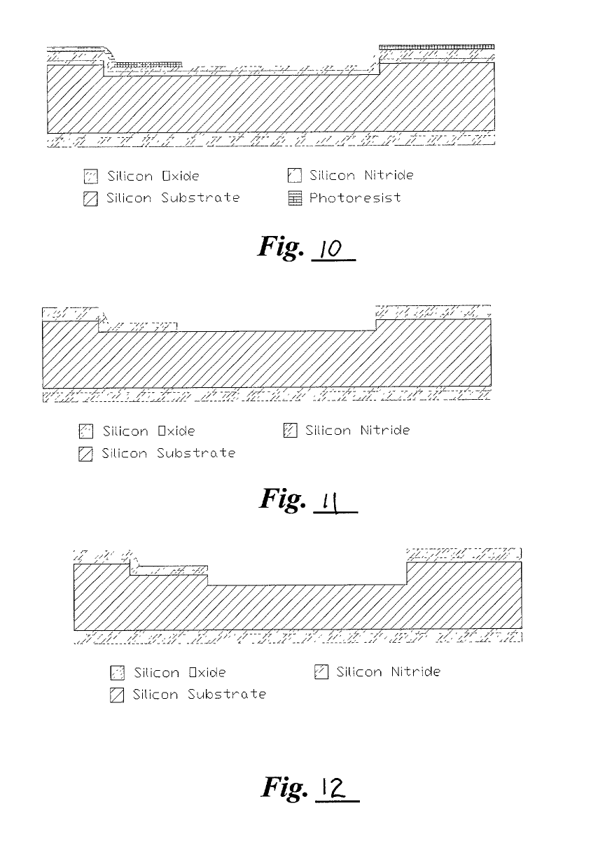

1.10 Expose with photo mask A2-2F-KOH2 for front side, which opens the front side patterns for active region for sol-gel (refer to FIG. 10).

1.11 RIE dielectrics down to bare Si on front side using CHF₃ and O₂. Strip photoresist and clean wafer (refer to FIG. 11).

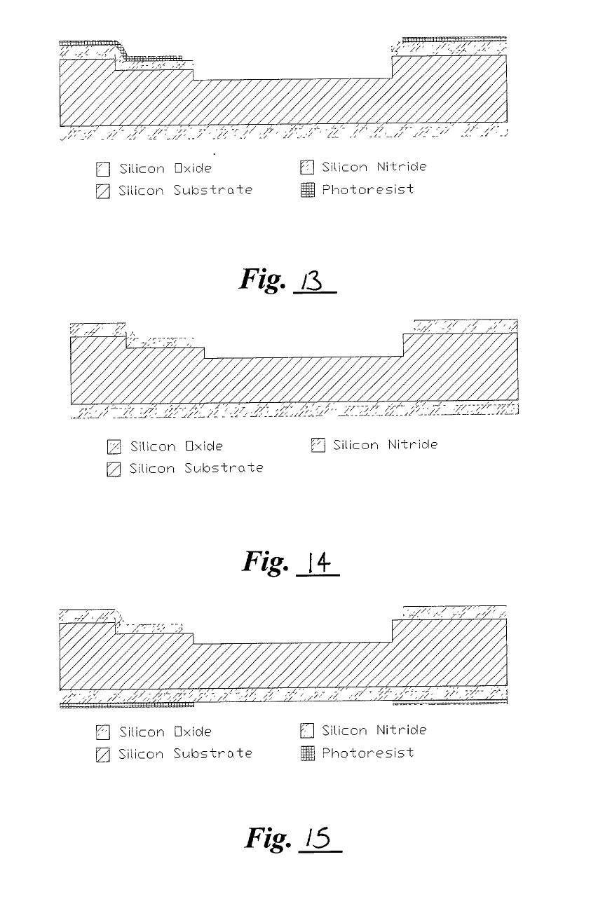

1.12 KOH etch 100 μm in stirred 28% KOH, at 75° C. (refer to FIG. 12).

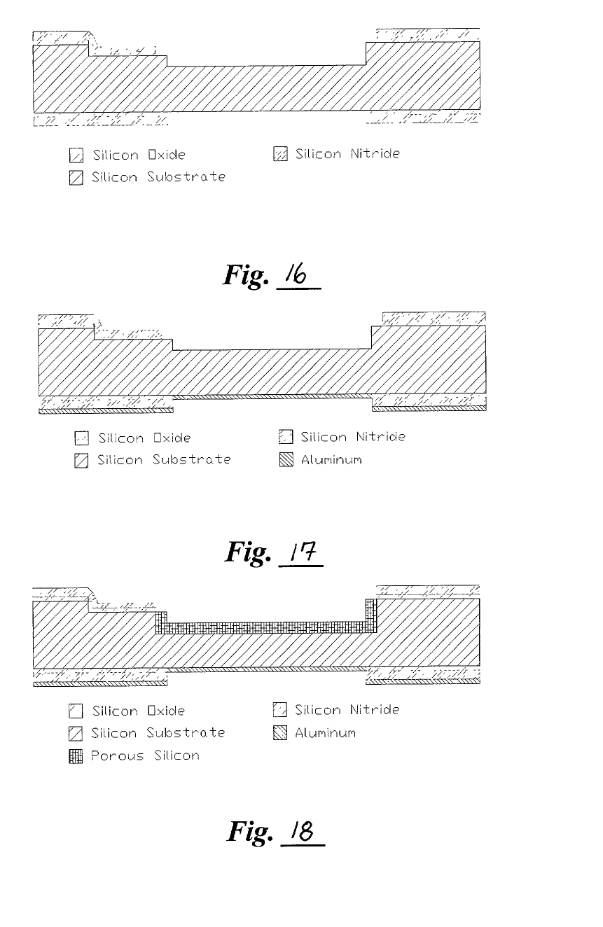

1.13 Use photo mask A2-3F-PSPAD on front side, with AZ4620, for conductive strip (refer to FIG. 13).

1.14 RIE dielectrics 500 μm in width using CHF₃ and O₂ on front side to make PS strip (refer to FIG. 14).

1.15 Use photo mask A2-4B-OHMIC on back side with photoresist AZ1518 to create openings for ohmic contact for anodic etching (refer to FIG. 15).

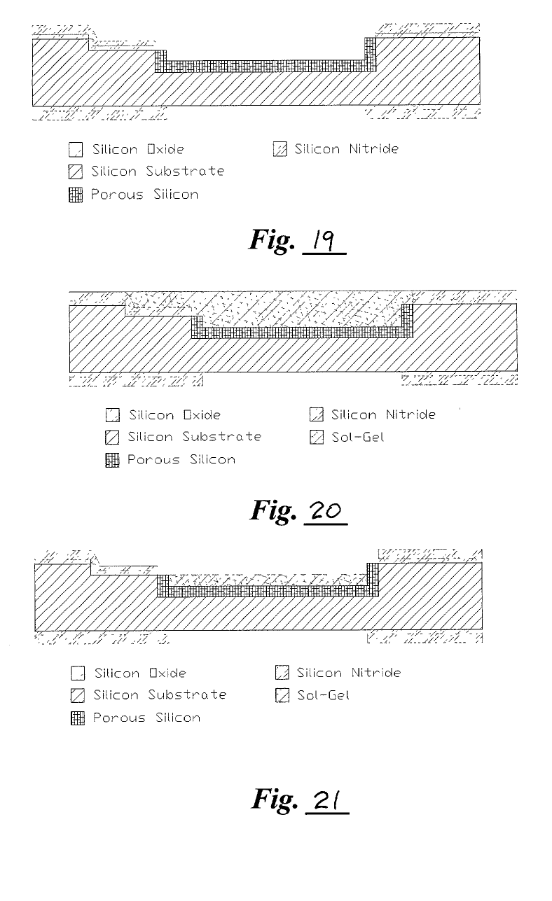

1.16 RIE dielectrics on back side to bare Si using CHF₃ and O₂. Then strip photoresist and clean wafer (refer to FIG. 16).

1.17 Evaporate 1 μm Al on backside for anodic etching ohmic contact (refer to FIG. 17).

1.18 Anodic etch 50 μm (PS etch for macropores) in active region where sol-gel will be cast (refer to FIG. 18).

1.19 Wet etch Al (refer to FIG. 19).

1.20 Cast sol-gel precursor solution (refer to FIG. 20).

1.21 Heat treat at 120° C. for 24 hours, pyrolyze at 450° C. for 4 hours under flowing H₂ (refer to FIG. 21).

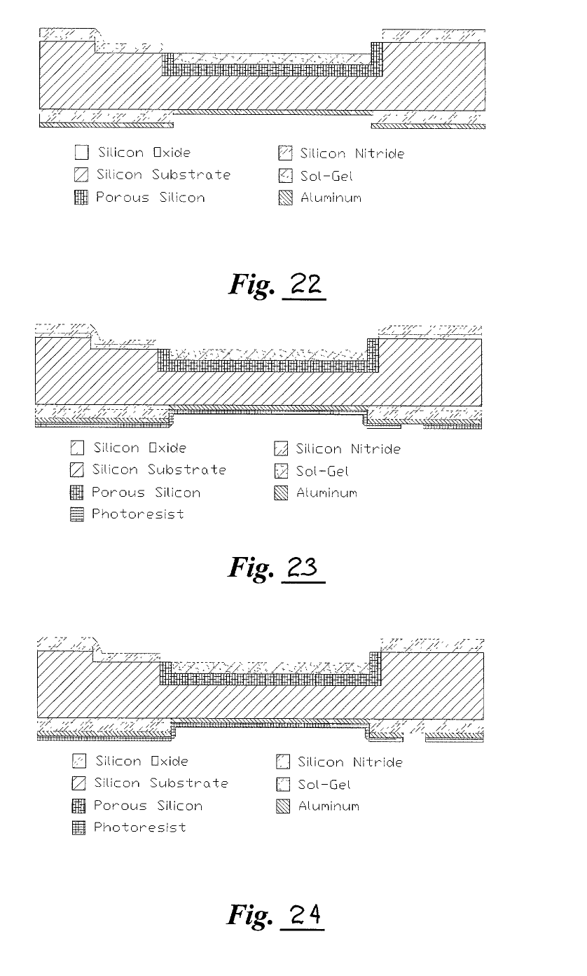

1.22 Evaporate 1 μm Al on backside as an RIE mask (refer to FIG. 22).

1.23 Use photo mask A2-5B-RIE1 on back side with photoresist AZ4620, to create offset right feed port (refer to FIG. 23).

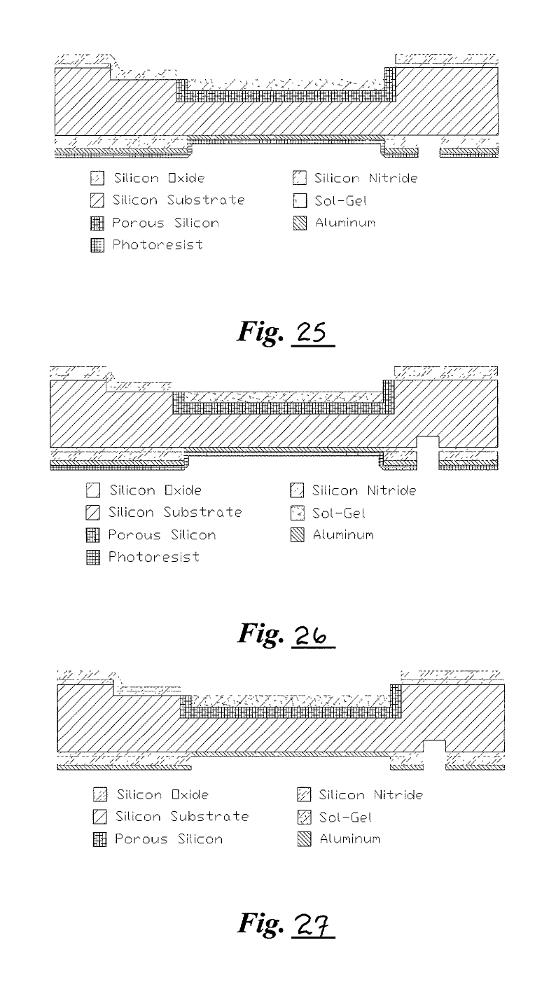

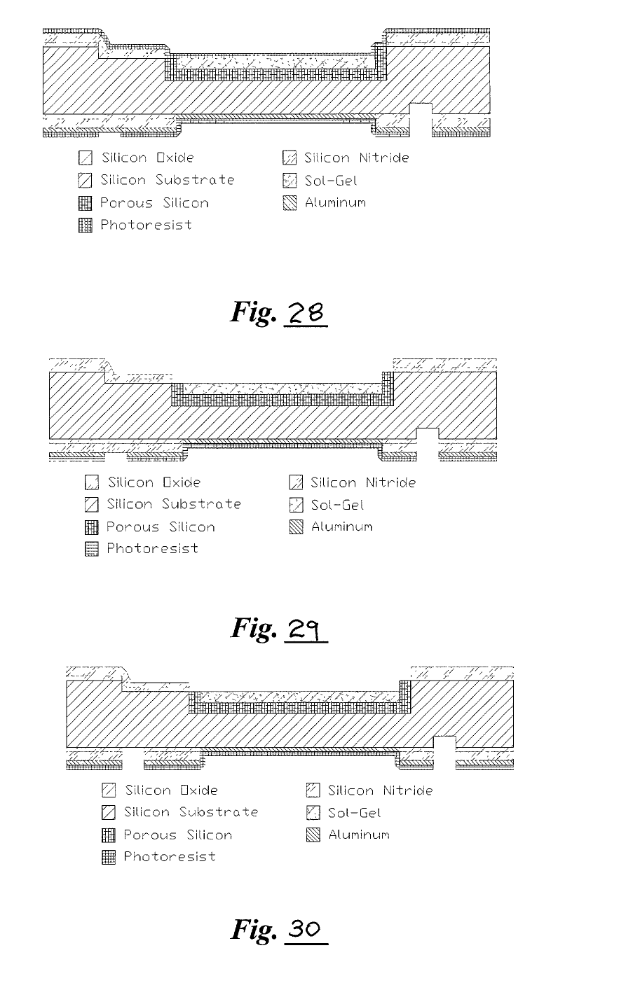

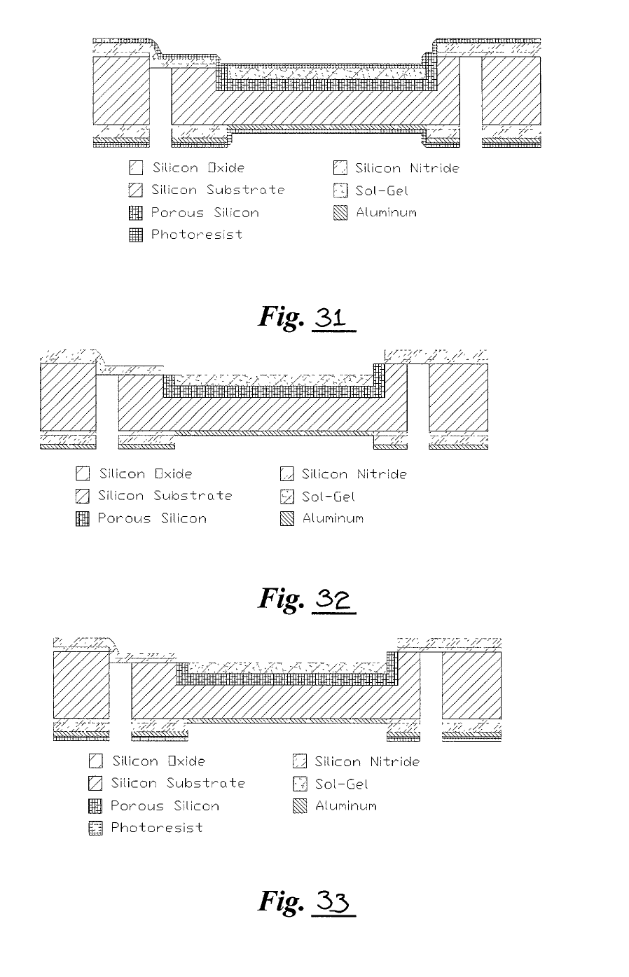

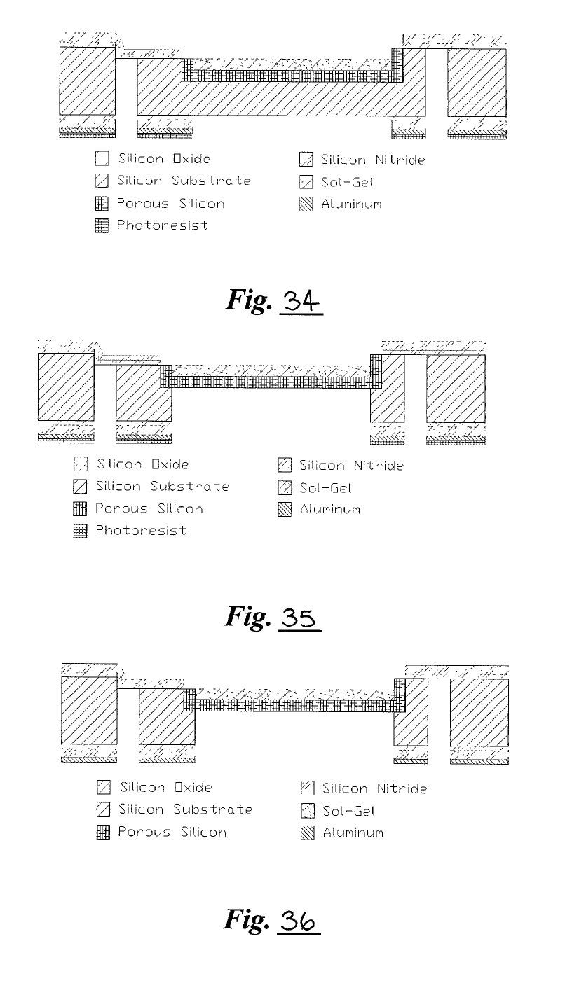

1.24 Wet etch Al at port area on back side (refer to FIG. 24).

1.25 RIE dielectrics using CHF₃ and O₂ on back side at port opening (refer to FIG. 25).

1.26 RIE 100 μm Si on backside at port opening using SF₆ (refer to FIG. 26).

1.27 Strip photoresist and clean wafer (refer to FIG. 27).

1.28 Use photo mask A2-6B-DRIE on back side, with photoresist Az4620, for DRIE shield (refer to FIG. 28).

1.29 Wet etch Al at port area on back side (refer to FIG. 29).

1.30 RIE dielectrics using CHF₃ and O₂ at port area on back side (refer to FIG. 30).

1.31 DRIE to the dielectric interface on the front side (refer to FIG. 31).

1.32 Strip photoresist and clean wafer (refer to FIG. 32).

1.33 Use photo mask A2-7B-RIE2 with AZ4620 on the back side to expose Si for etching (refer to FIG. 33).

1.34 Wet etch Al (refer to FIG. 34).

1.35 RIE Si using CHF₃ and O₂ until porous silicon is reached, which is approximately 50 μm (refer to FIG. 35).

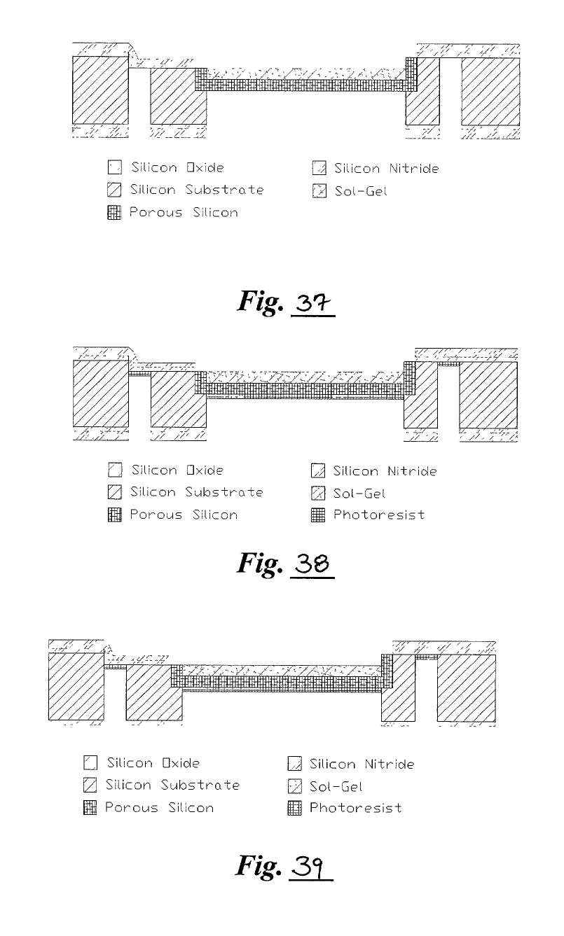

1.36 Strip photoresist and clean wafer (refer to FIG. 36).

1.37 Wet etch all Al (refer to FIG. 37).

1.38 Use photo mask A2-8B-LIFTOFF1 on the back side with AZ4620, to provide conductive layer and bonding interface (refer to FIG. 38).

1.39 RIE all of back side nitride (Si₃N₄) using CHF₃ and O₂ (refer to FIG. 39).

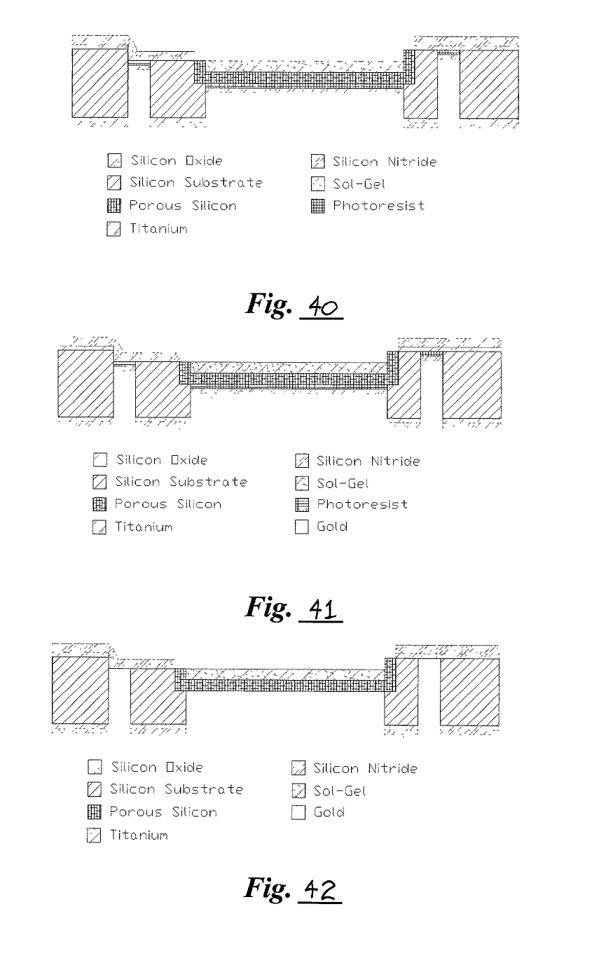

1.40 Evaporate Ti adhesion layer for successive Au layer on the back side (refer to FIG. 40).

1.41 Evaporate 2 μm of Au on back side (refer to FIG. 41).

1.42 Ti-Au lift-off using acetone (refer to FIG. 42).

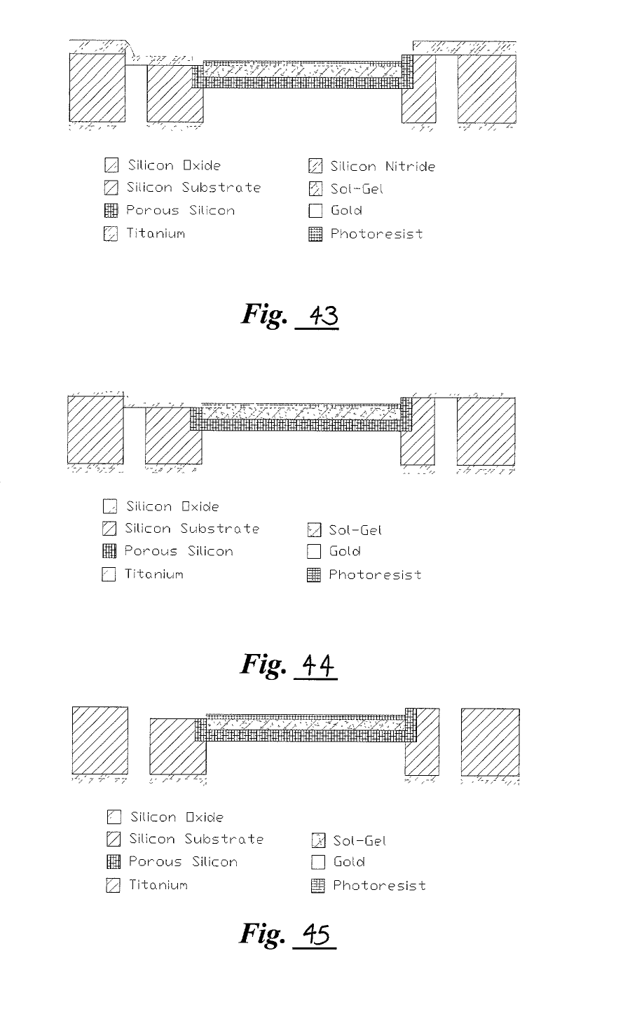

1.43 Use photo mask A2-9F-LIFTOFF2 on the front side with AZ4620, to provide conductive layer and bonding interface (refer to FIG. 43).

1.44 RIE dielectrics on front side using CHF₃ and O₂ (refer to FIG. 44).

1.45 RIE dielectrics on front side (refer to FIG. 45).

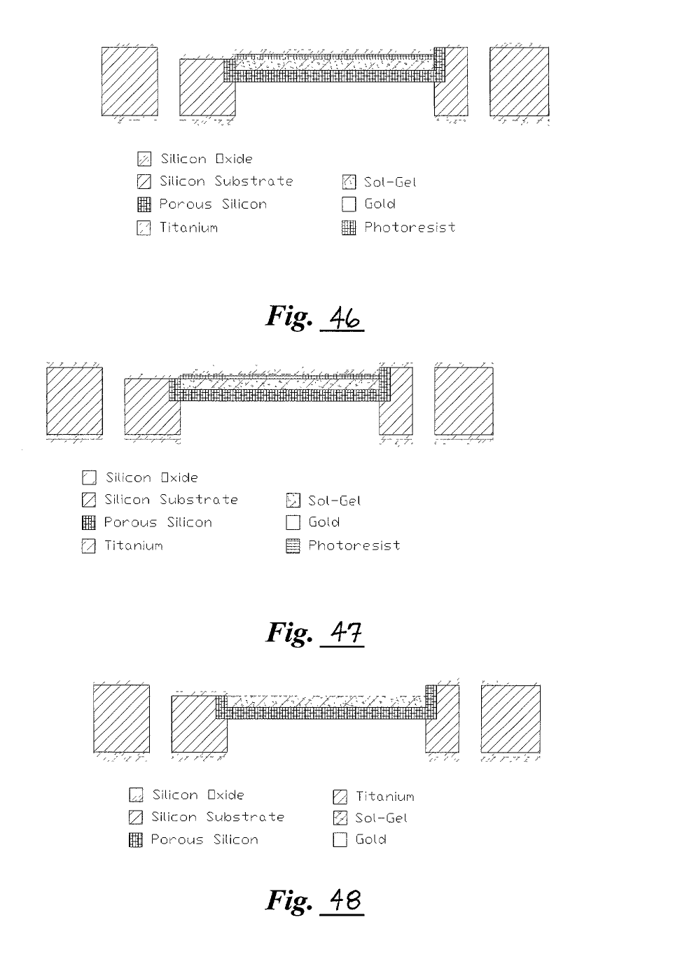

1.46 Evaporate Ti adhesion layer for successive Au layer on front side (refer to FIG. 46).

1.47 Evaporate 2 μm of Au on front side (refer to FIG. 47).

1.48 Front side Ti-A side Ti-Au lift-off using acetone (refer to FIG. 48).

CATHODE FABRICATION-Start with a silicon substrate having the following characteristics: 300 μm double side polished, (100) crystal orientation, 1 to 1.0 Ω-cm, n-type, 100 mm (4″) diameter, and process in accordance with the following steps:

2.1 Nitride Deposition-1000 Å, S1 (front side) and S2 (back side).

2.2 Photo Mask C2_1F_PS for front side, S1, using photoresist AZ1512 (refer to FIG. 49).

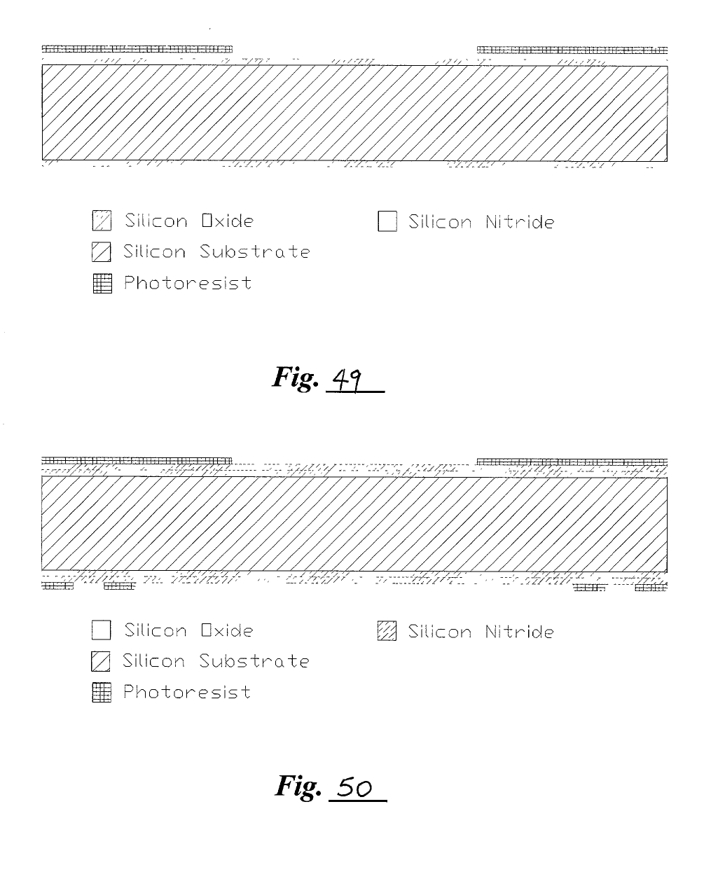

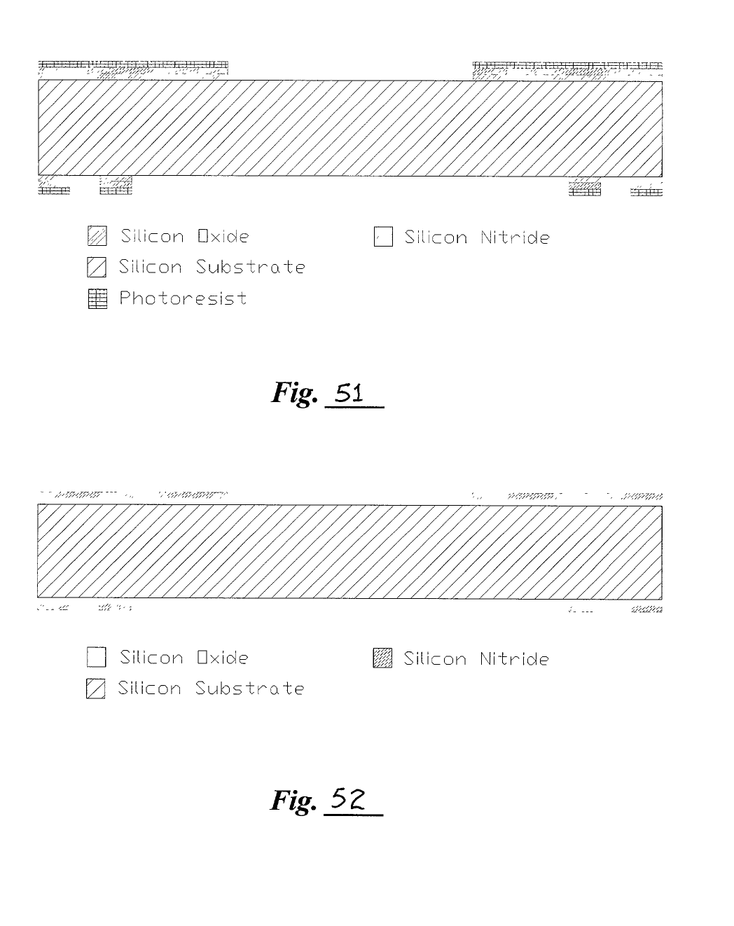

2.3 Photo Mask C2_2B_OHMIC for backside, S2, using photoresist AZ1512 (refer to FIG. 50).

2.4 RIE nitride both front and backside (refer to FIG. 51).

2.5 Strip photo resists and clean wafer (refer to FIG. 52).

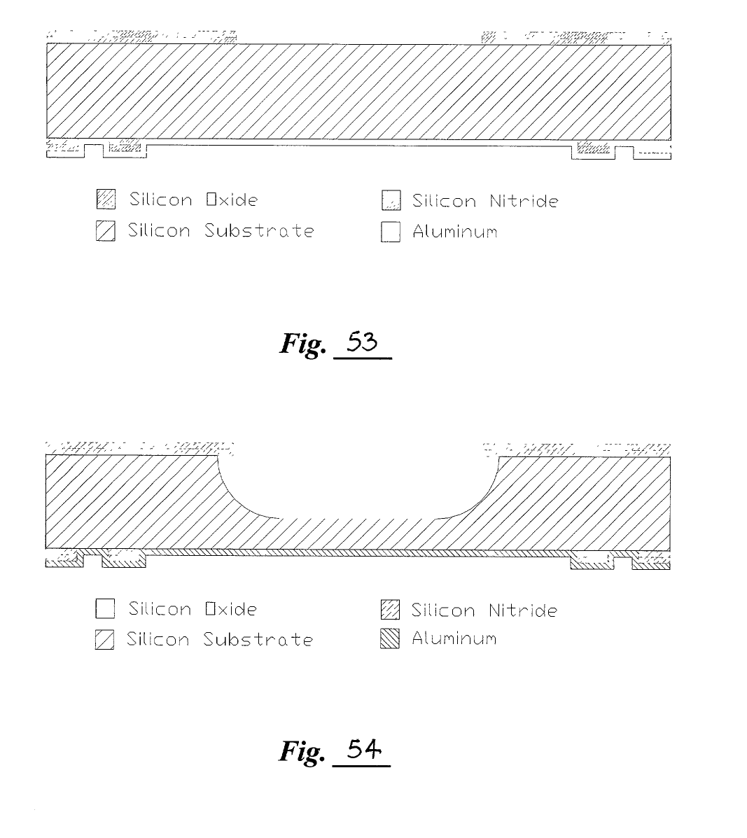

2.6 Evaporate 1 μm of Al on backside, S2 (refer to FIG. 53).

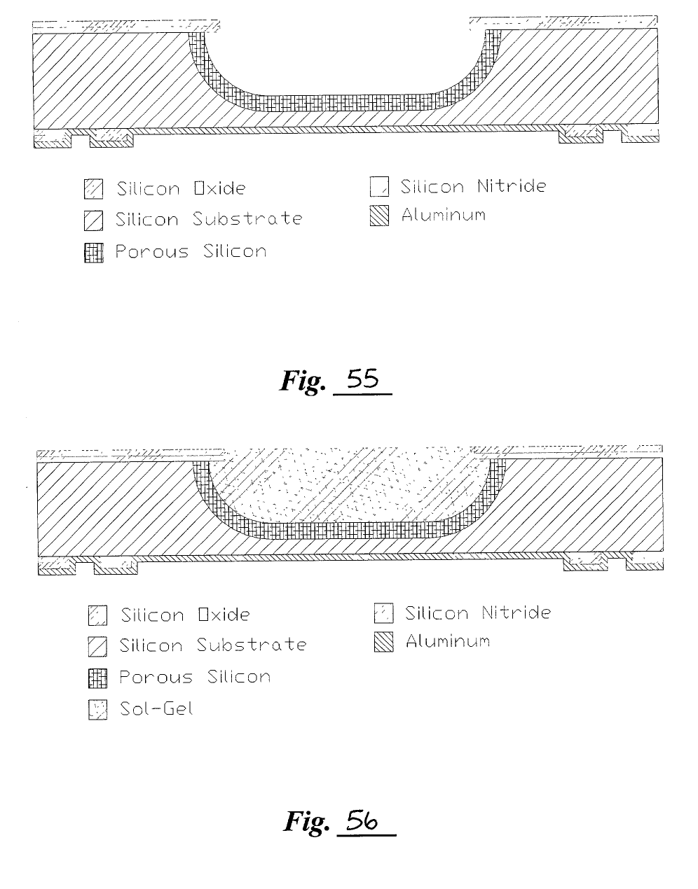

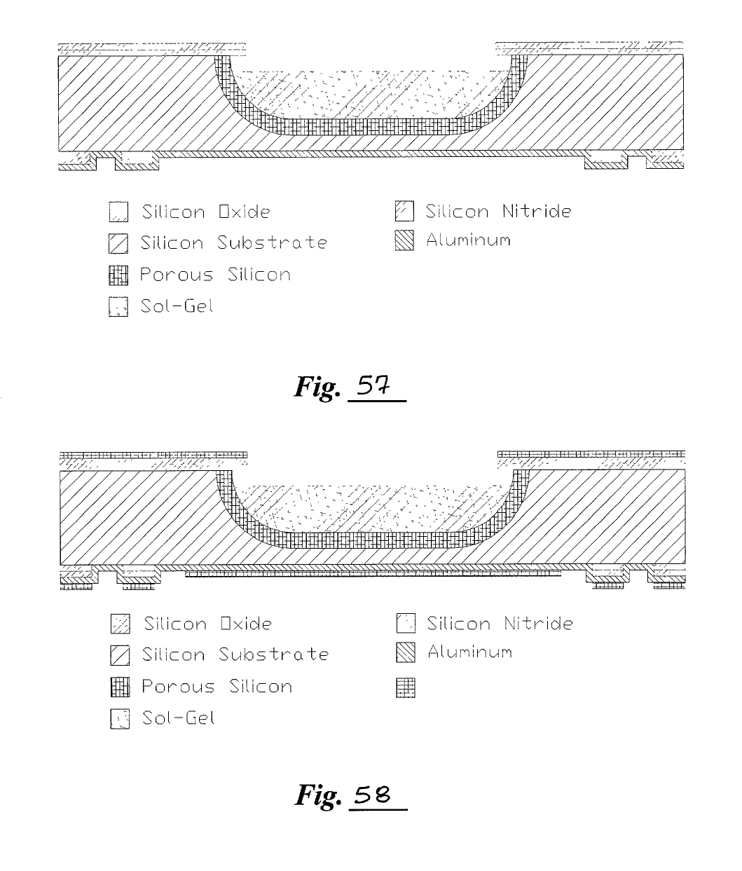

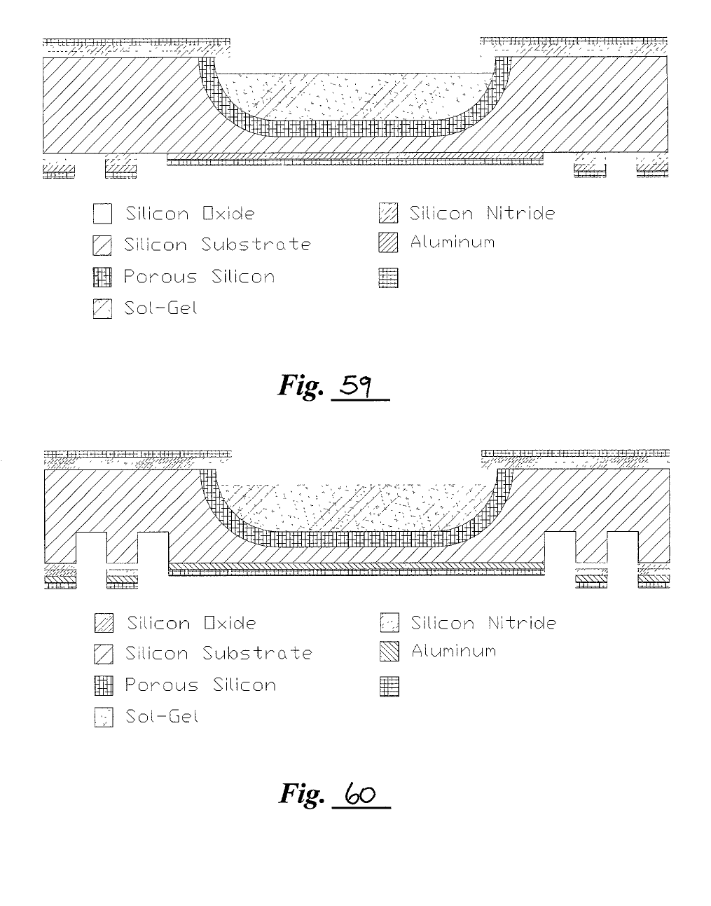

2.7 Isotropic etch: HF:HNO₃:CH₃COOH, etch out 200 μm Si (refer to FIG. 54).

2.8 Anodic etch 50 μm porous structure on front side (refer to FIG. 55).

2.9 Cast sol-gel precursor solution (refer to FIG. 56).

2.10 Heat treat at 120° C. for 24 hours (refer to FIG. 57).

2.11 Pyrolyze at 500° C. for 4 hours under flowing H₂.

2.12 Spin on photoresist on front side, S1, using photoresist AZ4620 (refer to FIG. 58).

2.13 Photo mask C2_3B_OFFSET, S2, using photoresist AZ4620.

2.14 Etch Al (refer to FIG. 59).

2.15 RIE 100 μm with SF₆ (refer to FIG. 60).

2.16 Photo Mask C2_4B_DRIE, S2, using photoresist AZ4620 (refer to FIG. 61).

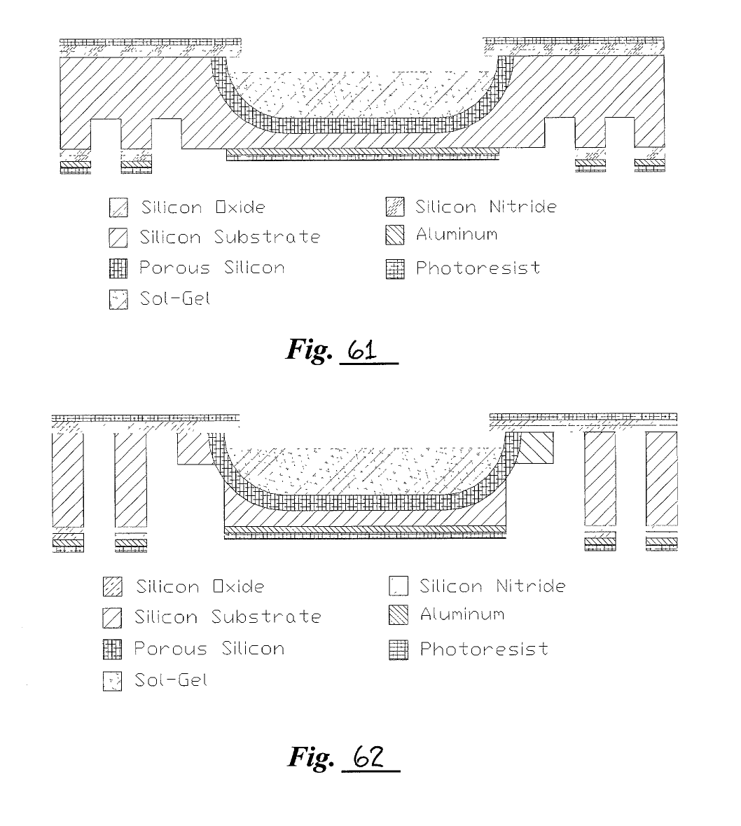

2.17 DRIE 200 μm (refer to FIG. 62).

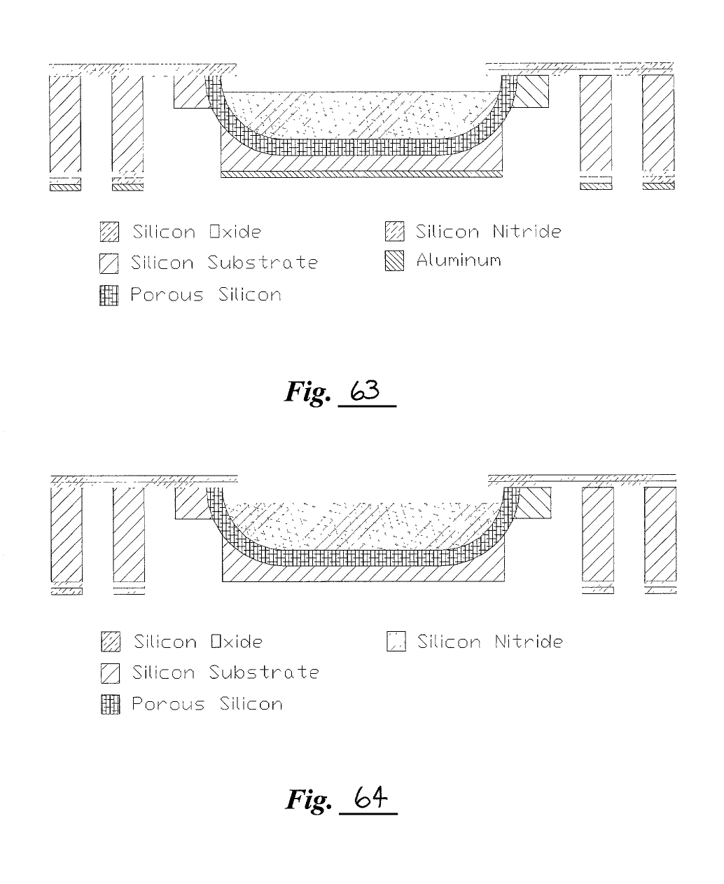

2.18 Strip photoresist on both sides, S1 and S2 (refer to FIG. 63).

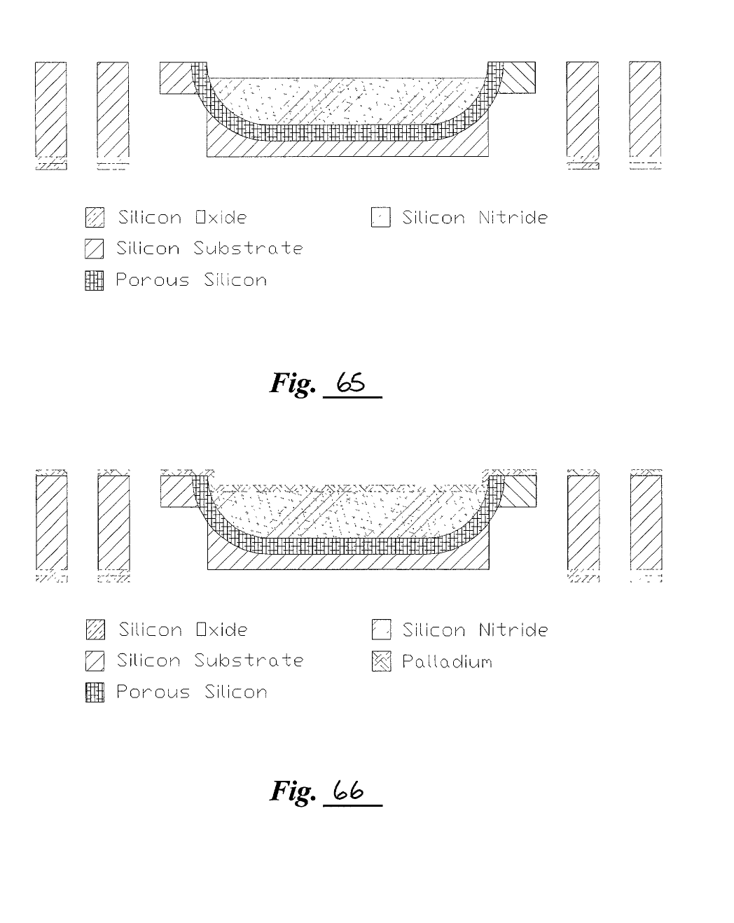

2.19 Strip Al (refer to FIG. 64).

2.20 RIE nitride front side, S1 (refer to FIG. 65).

2.21 Sputter Pd 2000 Å on the front side, S1 (refer to FIG. 66).

2.22 Photo Mask C2_5F_PLATING (refer to FIG. 67).

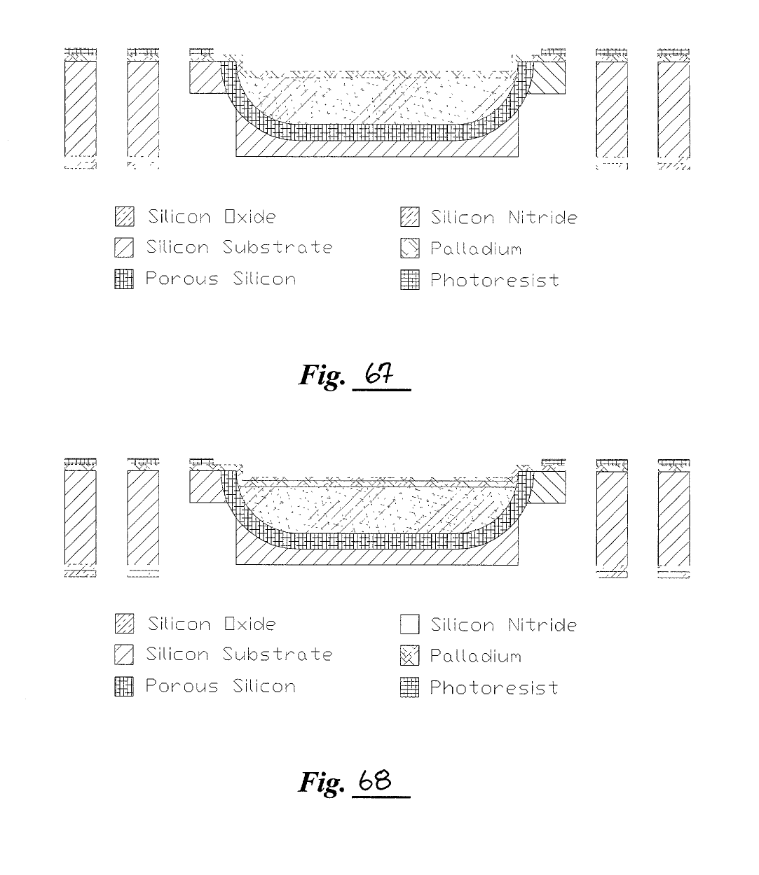

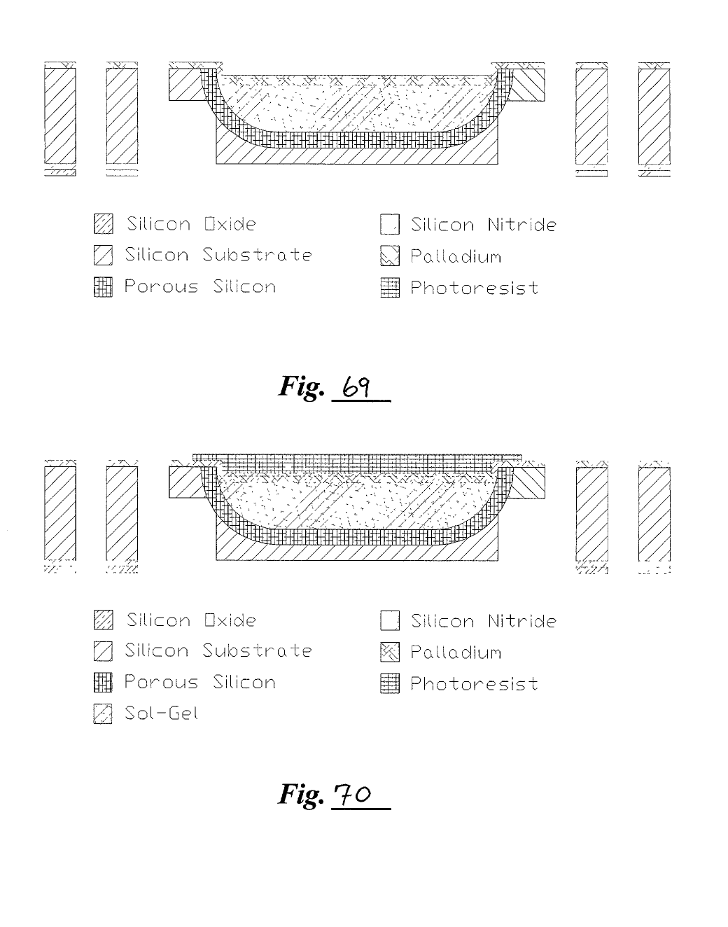

2.23 Pulse plate Pd thin film (refer to FIG. 68).

2.24 Strip Photoresist and clean wafer (refer to FIG. 69).

2.25 Photo Mask C2_6F_PDETCH (refer to FIG. 70).

2.26 Etch Pd (refer to FIG. 71).

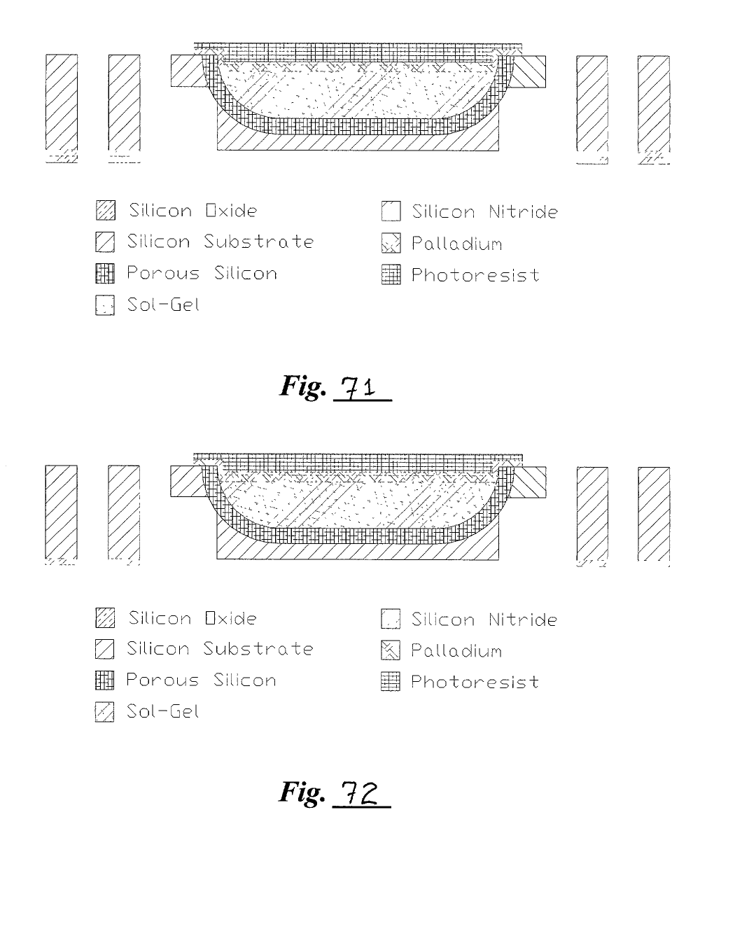

2.27 RIE dielectrics on backside (if required for bonding) (refer to FIG. 72).

2.28 Sputter external electrical connections on backside (if required for bonding) and (a) sputter 500 angstrom TiW and (b) Sputter 2 μm Au for metal connects (refer to FIG. 73).

While the sol-gel electrode of the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

We claim:

1. An electrode structure adapted for use with a fuel cell system, characterized in that the electrode structure comprises a support structure having a one or more discrete porous regions, wherein each of the one or more discrete porous regions comprise a sol-gel.

2. The electrode structure of claim 1 wherein the fuel cell system is a direct methanol fuel cell system.

3. The electrode structure of claim 1 wherein the support structure comprises silicon.

4. The electrode structure of claim 1 wherein the support structure is derived from a silicon wafer.

5. The electrode structure of claim 1 wherein the one or more discrete porous regions defines inner pore surfaces, wherein the inner pore surfaces have catalyst particles uniformly dispersed thereon.

6. The electrode structure of claim 5 wherein the catalyst particles comprise a plurality of chemisorbed metallic particles.

7. The electrode structure of claim 8 wherein the plurality of chemisorbed metallic particles are platinum, ruthenium, or a combination thereof.

8. The electrode structure of claim 1 wherein the sol-gel comprises platinum ruthenium dioxide, platinum-ruthenium-silicon oxide, platinum-ruthenium-titanium oxide, platinum-ruthenium-zirconium oxide, platinum-ruthenium-aluminum oxide, or a combination thereof.

9. The electrode structure of claim 8 wherein the sol-gel comprises platinum ruthenium dioxide.
